(19) United States
(12) Patent Application Publication
(10) Pub. No.: US 2010/0243743 A1
(43) Pub. Date: Sep. 30, 2010

(54) RADIO FREQUENCY IDENTIFICATION TAG AND METHOD FOR MANUFACTURING THE SAME

(75) Inventors: Shuichi TAKEUCHI, Kawasaki-shi (JP); Kenji KOBAE, Kawasaki-shi (JP); Takayoshi MATSUMURA, Kawasaki-shi (JP); Tetsuya TAKAHASHI, Kawasaki-shi (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: FUJITSU LIMITED, Kawasaki-shi (JP)

(21) Appl. No.: 12/723,174

(22) Filed: Mar. 12, 2010

(30) Foreign Application Priority Data
Mar. 30, 2009 (JP) 2009-83758

(51) Int. Cl. G06K 19/077; G06K 19/02; B29C 65/02; B29C 65/48

(52) U.S. Cl. 235/488; 264/272.17; 156/242; 264/571

(57) ABSTRACT

A radio frequency identification tag is provided. The radio frequency identification tag includes a base, an antenna formed on the base, an integrated circuit chip electrically connected to the antenna, and a bonding layer bonding the integrated circuit chip to the base. The bonding layer includes a conductive filler. The base is configured to bend away from a surface on which the integrated circuit chip is bonded.

### CROSS-REFERENCE TO RELATED APPLICATION

This application is based upon and claims the benefit of priority of the prior Japanese Patent Application No. 2009-83758, filed on Mar. 30, 2009, the entire contents of which are incorporated herein by reference.

### FIELD

The embodiments discussed herein are related to a radio frequency identification (RFID) tag and a method for manufacturing the RFID tag.

### BACKGROUND

In recent years, RFID tags configured to receive power supply and data from external devices, such as reader/writers, and to transmit data to the external devices by using electric waves in a non-contact manner have been available.

A RFID tag includes a transmitting/receiving antenna and an integrated circuit (IC) chip disposed on a substrate composed of plastic, paper, or the like. The antenna and a capacitor inside the IC chip form a resonant circuit so that the RFID tag can communicate wirelessly with external devices through the antenna.

The outline of a method for manufacturing a common RFID tag will now be described with reference to FIGS. 11 to 16. FIGS. 11 to 16 are diagrams illustrating a typical method for manufacturing a common RFID tag.

As illustrated in FIG. 11, first, a base 3, on which an antenna 4 is disposed, is placed on a stage 2 functioning as a working table. An adhesive 7 is discharged from a nozzle 6 to cover an upper surface of the base 3 and regions near an opening 5 in the antenna 4. The adhesive 7 covering the upper surface of the base 3 and the regions near the opening 5 in the antenna 4 will form a bonding layer that bonds the base 3 to an IC chip 10.

Next, as illustrated in FIG. 12, the IC chip 10 including a pair of electrodes 11 is placed above the base 3. The upper surface (the upper surface in FIG. 12) of the IC chip 10 is pressed downward and heated with a bonding device 12 to press-bond the IC chip 10 onto the base 3.

During this operation, as illustrated in FIG. 13, the inner portion of the antenna 4 on the base 3 may be fixed while being bent downward due to the heat and pressure applied by the bonding device 12. As illustrated in FIG. 14, the IC chip 10 is bonded to the base 3 with a bonding layer composed of an adhesive thermally cured by application of heat and pressure by the bonding device 12.

Next, as illustrated in FIG. 15, an elastomer member 13 and a reinforcing plate 14 are disposed in that order above the base 3 bonded with the IC chip 10, and another elastomer member 13 and another reinforcing plate 14 are disposed in that order under the base 3 bonded with the IC chip 10. While the base 3 is being surrounded by packages 2′, heat and pressure are applied to the packages 2′ by the bonding device 12 (FIG. 12) to enclose the base 3, the IC chip 10, and the reinforcing plates 14 inside the packages 2′.

As a result of performing the steps illustrated in FIGS. 11 to 15 described above, a RFID tag 1′ including the base 3 provided with the antenna 4, the IC chip 10 bonded to the base 3, and the two reinforcing plates 14 respectively disposed above and under the base 3 can be produced, as illustrated in FIG. 16.

RFID tags may be employed in a distribution field to manage linen goods such as uniforms, for example. In order to use RFID tags for linen management, a quantity of RFID tags equal to the number of uniforms are necessary, and thus the unit price of the RFID tag should be low.

However, RFID tags for apparel or linen goods cannot withstand external force applied during washing or the like unless the nearby regions of IC chips are protected with reinforcing plates. As illustrated in FIG. 16, a pair of reinforcing plates 14 must be formed inside the RFID tag 1′ (above the IC chip 10 and below the base 3), which increases the cost because more components are required.

Japanese Laid-open Patent Publication No. 6-204654 (“JP 6-204654”) discloses a printed board, which is one structure of a RFID tag of this type that has been used before. According to the disclosure of JP 6-204654, thermal press-bonding is performed while having a lead tip of a tape carrier package mounted on a conductive pad on the printed board, and a reinforcing plate is bonded and fixed on the rear surface of the printed board at a position corresponding to the conductive pad.

However, according to the RFID tag 1′ in related art, the antenna 4 is pressed downward by the electrodes 11 of the IC chip 10 due to the heat and pressure applied by the bonding device 12. Since the antenna 4 bends inward as a result of the applied heat and pressure by the bonding device 12, a conductive filler 8 may become trapped (i.e., “a” in FIG. 13) or the antenna 4 may contact an edge of the IC chip 10 (i.e., “b” in FIG. 13), resulting in a short-circuit between the base 3 and the IC chip 10.

Furthermore, when press-bonding is carried out with the bonding device 12, a filler attack (i.e., “c” in FIG. 13), i.e., a phenomenon in which the conductive filler 8 containing a nickel material is brought into contact with an electric pattern formed on the rear surface of the IC chip 10, may occur. This causes problems such as scraping of an electric pattern of the IC chip 10.

As further described in JP 6-204654, deflection of the base 3 may cause the antenna 4 to contact the IC chip 10, which may result in a short-circuit between the base 3 and the IC chip 10.

### SUMMARY

According to an embodiment of the invention, there is provided a radio frequency identification tag. The radio frequency identification tag includes a base, an antenna formed on the base, an integrated circuit chip electrically connected to the antenna, and a bonding layer bonding the integrated circuit chip to the base. The bonding layer includes a conductive filler. The base is configured to bend away from a surface on which the integrated circuit chip is bonded.

The object and advantages of the invention will be realized and achieved by means of the elements and combinations particularly pointed out in the claims.

It is to be understood that both the foregoing general description and the following detailed description are exemplary and explanatory, and are not restrictive of the invention, as claimed.

### BRIEF DESCRIPTION OF DRAWINGS

The above and other features and advantages of the invention will become apparent from the following description of the embodiments in conjunction with the accompanying drawings, wherein:

FIG. 1 is a vertical cross-sectional view illustrating a RFID tag in accordance with an embodiment of the invention.

FIG. 2 is a plan view illustrating a surface of an IC chip in accordance with an embodiment of the invention.

FIG. 3 is a plan view illustrating a rear surface of the IC chip in accordance with an embodiment of the invention.

FIG. 4 is a flowchart of a method for manufacturing a RFID tag in accordance with an embodiment of the invention.

FIG. 5 is a diagram illustrating the method for manufacturing a RFID tag in accordance with an embodiment of the invention.

FIG. 6 is a diagram illustrating the method for manufacturing a RFID tag in accordance with an embodiment of the invention.

FIG. 7 is a diagram illustrating the method for manufacturing a RFID tag in accordance with an embodiment of the invention.

FIG. 8 is a diagram illustrating the method for manufacturing a RFID tag in accordance with an embodiment of the invention.

FIG. 9 is a diagram illustrating the method for manufacturing a RFID tag in accordance with an embodiment of the invention.

FIG. 10 is a diagram illustrating a method for manufacturing a RFID tag in accordance with an embodiment of the invention.

FIG. 11 is a diagram illustrating a method for manufacturing a RFID tag.

FIG. 12 is a diagram illustrating the method for manufacturing a RFID tag.

FIG. 13 is a diagram illustrating the method for manufacturing a RFID tag.

FIG. 14 is a diagram illustrating the method for manufacturing a RFID tag.

FIG. 15 is a diagram illustrating the method for manufacturing a RFID tag.

FIG. 16 is a diagram illustrating the method for manufacturing a RFID tag.

### DESCRIPTION OF EMBODIMENTS

Embodiments of a RFID tag and a method for manufacturing the RFID tag to be disclosed by this application will now be described with reference to the attached drawings.

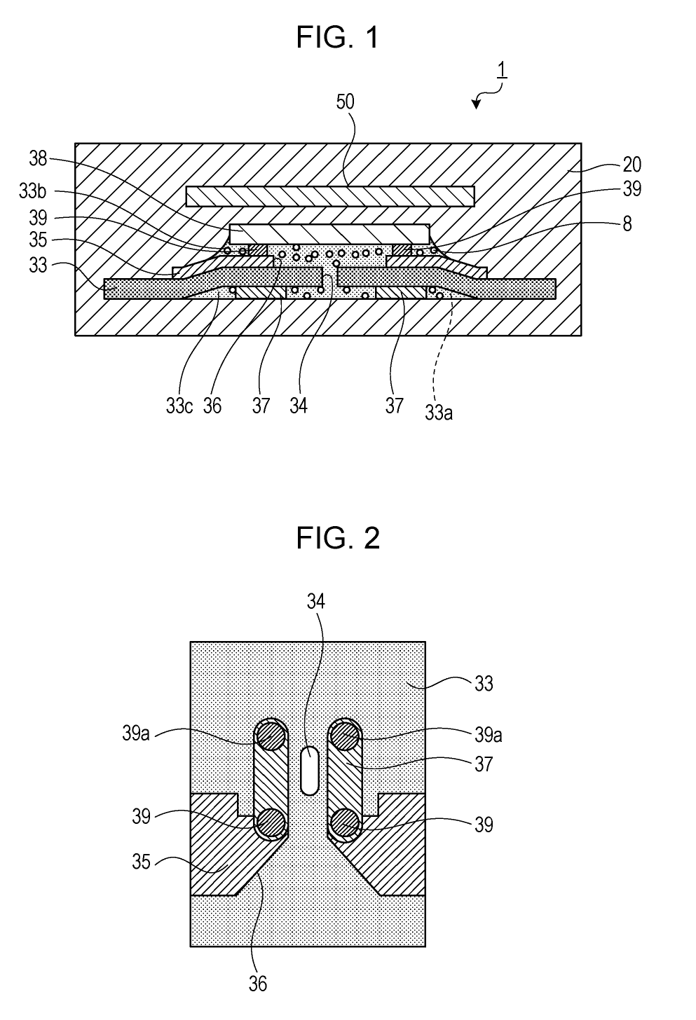

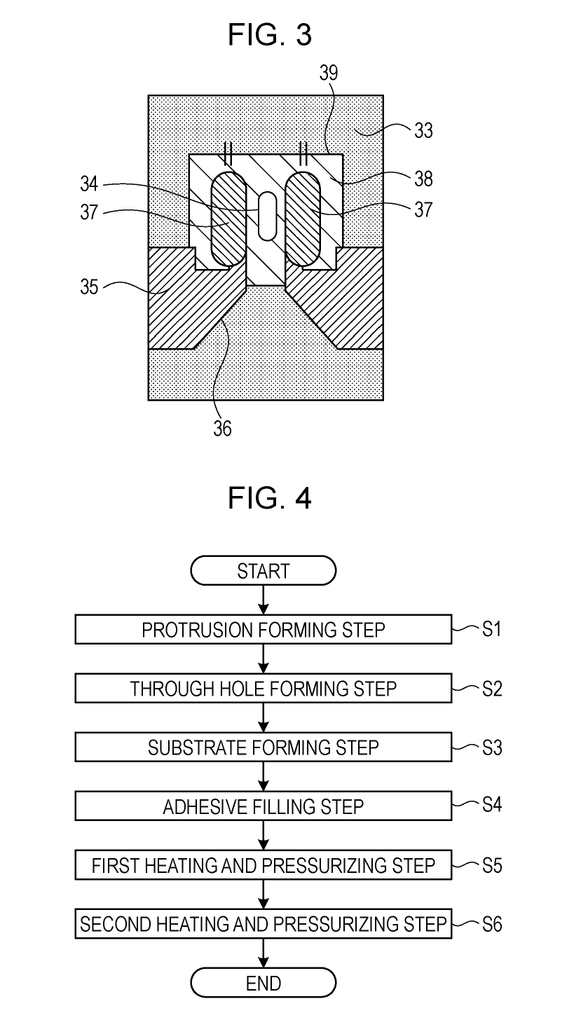

First, the overall configuration of a RFID tag 1 of an embodiment of the invention is described. FIG. 1 is a vertical cross-sectional view of a RFID tag of an embodiment of the invention. FIG. 2 is a plan view illustrating a mounting surface of an IC chip in accordance with an embodiment of the invention. FIG. 3 is a plan view illustrating the rear surface of the IC chip in accordance with an embodiment of the invention.

As illustrated in FIG. 1, the RFID tag 1 of can include a package main body 20 including a rectangular shape and a base 33 configured inside the package main body 20. The base 33 can include a surface on which an antenna 35 is disposed.

The RFID tag 1 can also include an IC chip 38 disposed on an upper surface of the base 33 and a reinforcing plate 50 disposed above the IC chip 38. The reinforcing plate 50 can be a glass epoxy plate in which a glass material and an epoxy material are combined. As described below, the reinforcing plate 50 can be configured to reinforce the upper part of the RFID tag 1.

As illustrated in FIG. 1, the base 33 including the antenna 35 can include a curved shape allowing it to bend away (downward in FIG. 1) from the surface on which the IC chip 38 above the base 33 can be bonded.

When the IC chip 38 is bonded onto the base 33 with an adhesive serving as a thermosetting material, a bonding layer 33b can be formed. A space (curved part) below the lower surface of the base 33 can also be filled with the adhesive. In particular, the adhesive filling a space 33a below the lower surface (curved part) of the base 33 can be cured by applying heat and pressure so that the lower part of the base 33 can be reinforced by the cured adhesive filling the space 33a.

In other words, according to the RFID tag 1 illustrated in FIG. 1 to FIG. 3, the upper part of the RFID tag 1 can be configured to retain strength by the reinforcing plate 50 and the lower part of the RFID tag 1 by being reinforced by curing the adhesive filling the space 33a below the lower surface of the base 33 under application of heat and pressure so as to retain the strength of the RFID tag 1.

For the base 33, a substrate, such as a polyethylene terephthalate (PET) film or a polyethylene naphthalate (PEN) film, that has high strength, high heat resistance, and high hydrolysis resistance can be used.

The antenna 35 can be formed of a conductor foil and can be mounted on a surface portion of the base 33 by a flip-chip technique. A pair of protrusions 37 can be disposed on the rear surface of the base 33.

Thus, the pair of protrusions 37 on the lower surface of the main body of the base 33 can allow the base 33 to bend away from (downward from in FIG. 1) the surface on which the IC chip 38 disposed above the base 33 is bonded. The space 33a below the lower surface of the base 33 created thereby can be filled with the adhesive which is cured to function as a reinforcing plate.

As illustrated in FIG. 3, the protrusions 37 attached to the base 33 can be positioned within the IC chip-mounted area. The protrusions 37 can be symmetric with respect to a line connecting the mount center point of the mounted IC chip 38 and the position that divides a chip side into equal lengths.

In other words, the pair of protrusions 37 can be provided so that a portion of the base 33 that extends over the size of the IC chip 38 bends away from the chip-mounting surface when the IC chip 38 is mounted. According to this structure of this embodiment, the short-circuit between the IC chip 38 and the base 33 can be prevented.

A through hole 34 can be formed at a center portion where the IC chip 38 is mounted on the base 33. An opening can be formed at the center of the antenna 35. The portion below the rear surface of the base 33 can be filled with an adhesive injected through the through hole 34 and cured by heat (thermally cured adhesive).

The IC chip 38 can include a communication circuit, a memory, and a controller circuit configured to record and read data without a manufacturing contact. The IC chip 38 can also include a pair of electrodes 39 configured to provide electrical connections to the antenna 35, and dummy posts 39a, as illustrated in FIG. 2, that are configured to adjust the height of the IC chip 38.

As described above, according to the RFID tag 1 illustrated in FIG. 1 to FIG. 3, since the base 33 of the RFID tag 1 can be configured to bend away from the surface on which the IC chip 38 is bonded, the contact between the base 33 and the IC chip 38 can be avoided, and the short-circuit between the IC chip 38 and the base 33 can be prevented.

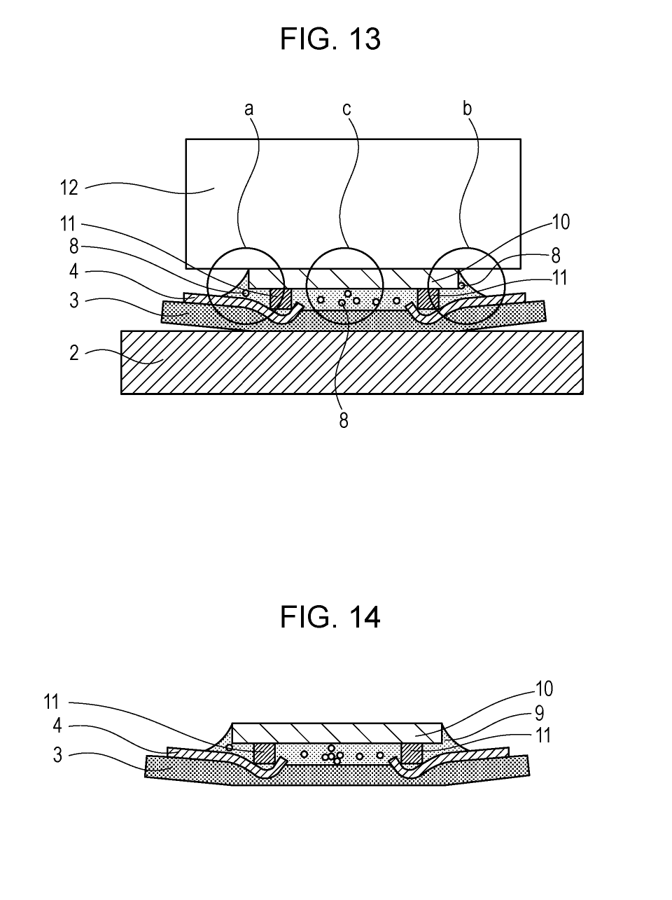

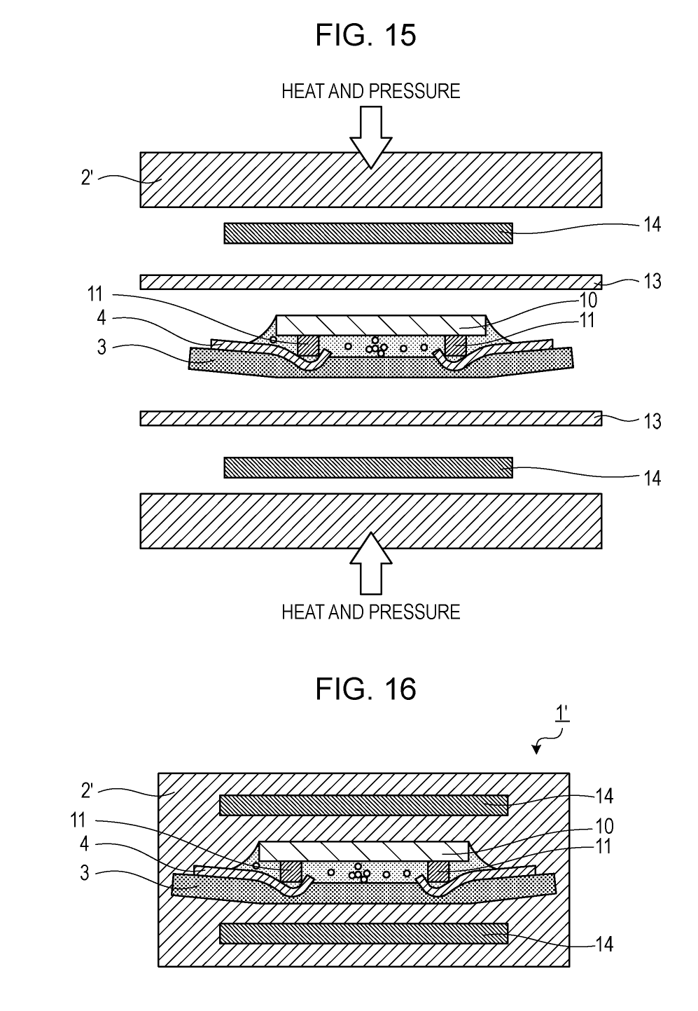

Since the base 33 of the RFID tag 1 can be configured to bend away from the surface on which the IC chip 38 is bonded, failures, such as trapping of the conductive filler 8 (“a” in FIG. 13) and scraping of the electric pattern of the IC chip 38 by a filler attack, i.e., contact with the conductive filler 8, can be avoided.

Since the RFID tag 1 can include the bonding layer 33b that bonds the IC chip 38 to the base 33 and the reinforcing layer that can be made of a thermosetting material (adhesive), and furthermore can function as a reinforcing plate disposed below the lower surface, i.e., the curved surface, of the base 33, the number of reinforcing plates 50 required can be reduced and the cost of the RFID tag 1 can be lowered.

A method for manufacturing the RFID tag 1 will now be described with reference to FIGS. 4 to 9. FIG. 4 is a flowchart illustrating a process for manufacturing the RFID tag 1 in accordance with an embodiment of the invention.

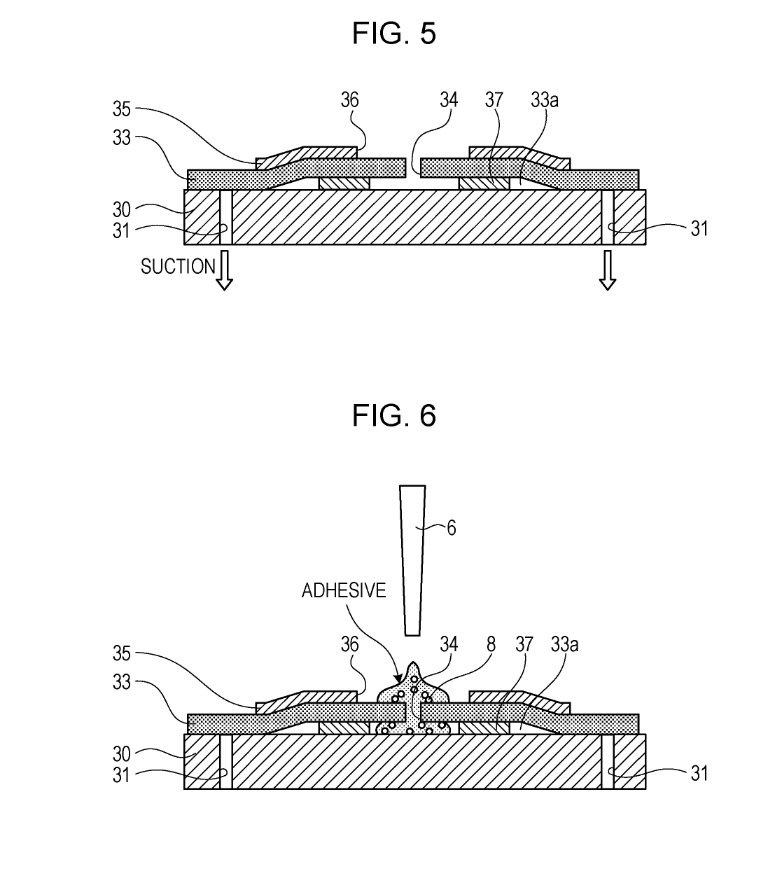

FIGS. 5 to 9 are diagrams illustrating a process for manufacturing the RFID tag 1 in accordance with an embodiment of the invention. In the description below describing the method for manufacturing the RFID tag 1, a production system, such as bonding equipment, can be used.

As illustrated in the flowchart of FIG. 4, according to the method for manufacturing the RFID tag 1 in accordance with an embodiment of the invention, a protrusion forming step, a through hole forming step, a substrate forming step, an adhesive filling step, a first heating and pressurizing step, and a second heating and pressurizing step are performed sequentially in that order by the production system.

First, a protrusion-forming step (step S1) of forming the protrusions 37 on the lower surface (rear surface) of the base 33 (FIG. 5) can be conducted. In this protrusion-forming step, the pair of protrusions 37 can be formed on the rear surface of the base 33 by bonding or etching. Forming the protrusions 37 on the rear surface of the base 33 allows the base 33 to bend in a particular direction (downward in FIG. 1).

Next, a through hole forming step (step S2) for forming the through hole 34 (FIG. 5) in the rear surface of the base 33 can be performed. In this through hole forming step, the through hole 34 that allows an adhesive to pass through can be formed so that the adhesive injected from the nozzle 6 can fill the portion below the rear surface of the base 33. Thus, because of the through hole 34 in the base 33, the portion below the back surface of the substrate can be filled with the adhesive. In particular, the through hole 34 can be formed by punching to allow the adhesive to enter the space 33a below the rear surface of the base 33 during mounting of the IC chip 38 on the base 33.

Next, a substrate forming step (step S3) of forming a base that functions as a substrate of the RFID tag 1 can be performed. In this substrate forming step, a particular shape can be imparted to the base 33 to be placed inside the RFID tag 1 (see the lower part of the FIG. 1).

To be more specific, according to the production system for the RFID tag 1 in accordance with an embodiment of the invention, as illustrated in FIG. 5, a stage 30 including a pair of through holes 31 formed in the respective end portions (left and right portions in FIG. 1) of the stage main body can be prepared. The base 33 including the antenna 35 can be placed on the upper surface of the stage 30. The parts of the stage 30 that make contact with the adhesive can be coated with Teflon (trade name) or the like to prevent adhesion of the adhesive.

Then, as illustrated in FIG. 5, the entire base 33 can be suctioned through the through holes 31 by using a suction device (not shown) from the rear surface of the stage 30. Since the pair of protrusions 37 can be disposed on the rear surface of the base 33, the base 33 can be deformed downward by the suction using the suction device. Since the base 33 can be configured to bend away from the surface on which the IC chip 38 is to be bonded, a short-circuit between the IC chip 38 and the base 33 can be prevented.

Next, the adhesive-filling step (step S4) for filling the portion below the base 33 with the adhesive can be performed. This adhesive-filling step is a step of forming a reinforcing layer under the base 33 with the adhesive.

To be more specific, as illustrated in FIG. 6, the adhesive, i.e., a thermosetting material, can be injected from the nozzle 6 through the opening 36 in the antenna 35 and the through hole 34 in the base 33. The adhesive injected through the opening 36 in the antenna 35 can form the bonding layer 33b that bonds the rear surface of the IC chip 38 onto the upper surface of the base 33. The adhesive injected from the nozzle 6 through the through hole 34 in the base 33 can fill the space 33a below the lower surface of the base 33.

Next, a first heating and pressurizing step (step S5) of heating and pressurizing the base 33 can be performed. The first heating and pressurizing step can be a step of heating and pressurizing the IC chip 38 disposed above the base 33 by using a bonding device 40.

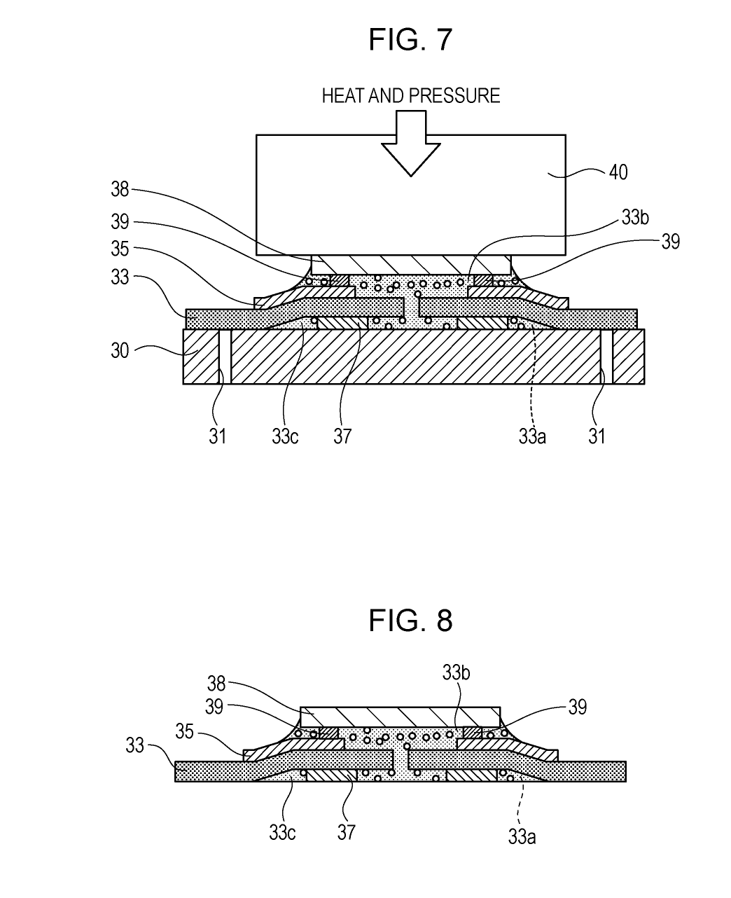

In particular, as illustrated in FIG. 7, the IC chip 38 can be placed above the base 33 and the upper surface (upper surface in FIG. 7) of the IC chip 38 can be pressurized and heated with the bonding device 40 so that the IC chip 38 is press-bonded onto the base 33.

During this operation, as illustrated in FIG. 8, the base 33 can be bonded to the IC chip 38 with the bonding layer 33b formed of the adhesive thermally cured by the heat and pressure applied from the bonding device 40. The adhesive filling the space 33a below the lower surface of the base 33 can be thermally cured and thereby can form a reinforcing layer 33c.

Next, a second heating and pressurizing step (step S6) for disposing an elastomer member 41 and the reinforcing plate 50 above the base 33 can be performed. This second heating and pressurizing step can be a step of heating and pressurizing the elastomer member 41 and the reinforcing plate 50 disposed above the base 33.

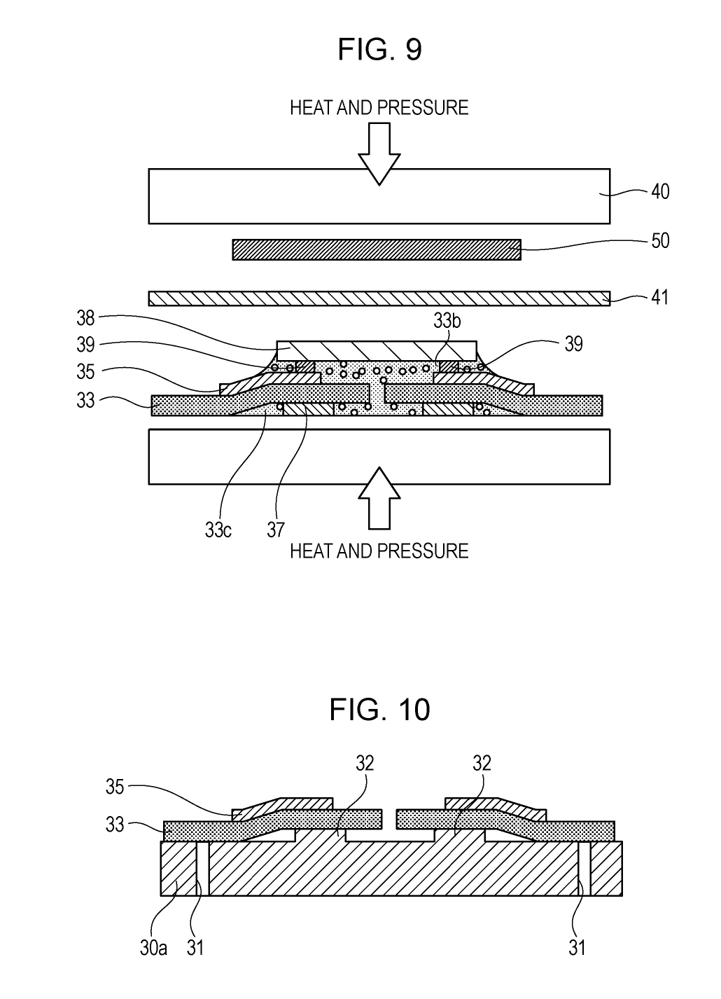

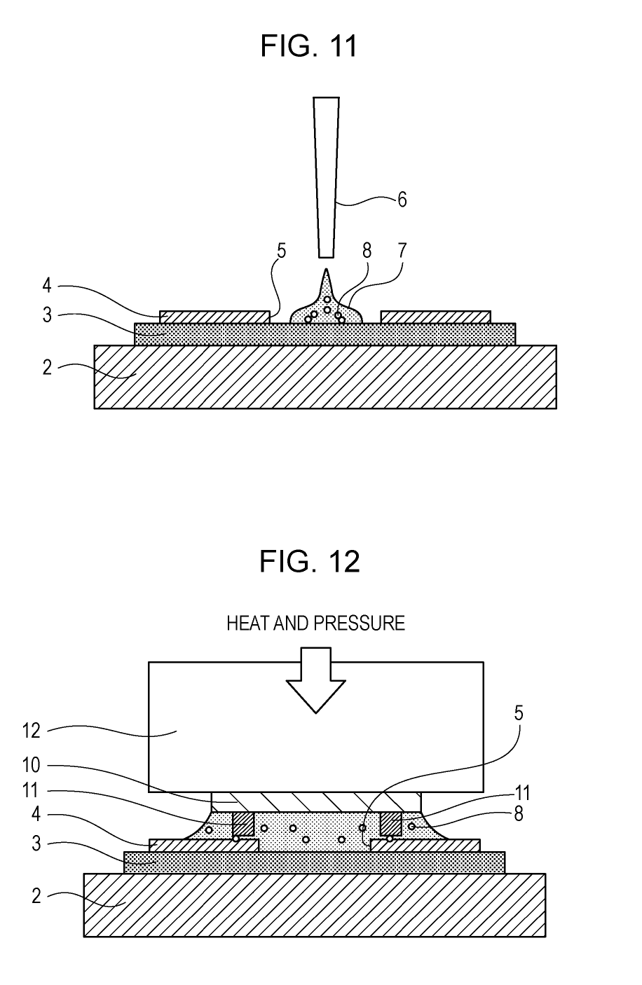

In particular, as illustrated in FIG. 9, the elastomer member 41 and then the reinforcing plate 50 can be placed above the base 33 bonded with the IC chip 38. Then while surrounding the base 33 with a package (not shown in the drawing), heat and pressure can be applied by the bonding device 40 from above and below the base 33 so that the base 33, the IC chip 38, and the reinforcing plate 50 are press-bonded inside the package.

By performing the steps illustrated in FIGS. 5 to 9, the RFID tag 1 can be made which can include the base 33 including the antenna 35, the IC chip 38 bonded to the base 33, the reinforcing plate 50 arranged above the base 33, and the reinforcing layer disposed below the curved surface of the base 33, the reinforcing layer being formed of a thermosetting material (adhesive) and serving as a reinforcing plate.

A method for manufacturing the RFID tag 1 in accordance with an embodiment of the invention will now be described. FIG. 10 is a diagram illustrating a method for manufacturing the RFID tag 1 in accordance with an embodiment of the invention. In the description below, the detailed description of the steps identical to the steps described in a previous embodiment is omitted.

According to the method for manufacturing the RFID tag in accordance with an embodiment of the invention, the base can be produced by using a stage 30a including a pair of protrusions 32 on which the base can be placed. That is, as illustrated in FIG. 10, the stage 30a that can include the pair of protrusions 32 on which the base 33 can be placed and a pair of through holes 31 respectively formed in the two end portions (left and right portions in FIG. 10) of the stage main body can be used.

According to the method for manufacturing the RFID tag in accordance with an embodiment of the invention, the pair of protrusions 32 fixed on the stage 30a can allow the base 33 to bend away from the IC chip 38 to be formed as in the method described above for another embodiment of the invention. In this manner, a short-circuit between the IC chip 38 and the base 33 can be prevented. The RFID tag can be reinforced by the thermosetting material (adhesive) filling the portion below the base, and thus the cost for an additional reinforcing plate can be cut. Since the step of forming the pair of protrusions 37 on the lower surface of the base 33 performed in a previously described embodiment can be omitted, the production steps can be streamlined.

For example, although the base 33 including the antenna 35 can be formed by manufacturing it to bend away from the surface on which the IC chip 38 is bonded, as previously described, a base that has been imparted a curved shape in advance so as to allow the portion below the base to be filled with the adhesive may be used.

All examples and conditional language recited herein are intended for pedagogical objects to aid the reader in understanding the invention and the concepts contributed by the inventors to further the art, and are to be construed as being without limitation to such specifically recited examples and conditions, nor does the organization of such examples in the specification relate to a showing of the superiority and inferiority of the invention. Although the embodiments of the invention have been described in detail, it will be understood by those of ordinary skill in the relevant art that various changes, substitutions, and alterations could be made hereto without departing from the spirit and scope of the invention as set forth in the claims.

What is claimed is:

1. A radio frequency identification tag comprising:
a base;
an antenna formed on the base;
an integrated circuit chip electrically connected to the antenna; and
a bonding layer bonding the integrated circuit chip to the base,
wherein the bonding layer comprises a conductive filler, and
wherein the base is configured to bend away from a surface on which the integrated circuit chip is bonded.

2. The radio frequency identification tag according to claim 1, further comprising:
a plurality of protrusions disposed on a rear surface of the base with respect to the surface on which the integrated circuit chip is bonded.

3. The radio frequency identification tag according to claim 2, wherein the plurality of protrusions comprise a pair of protrusions that are configured within an integrated circuit chip-mounted area.

4. The radio frequency identification tag according to claim 1, wherein the base comprises a through hole configured at the center portion of the base where the integrated circuit chip is mounted.

5. The radio frequency identification tag according to claim 4, further comprising:
a thermosetting material filled in a rear surface of the base through the through hole.

6. The radio frequency identification tag according to claim 1, further comprising:
a reinforcing plate formed above the integrated circuit,
wherein the reinforcing plate comprises a combination of a glass material and an epoxy material.

7. The radio frequency identification tag according to claim 3, wherein the pair of protrusions are configured to allow the base to bend away from the surface on which the integrated circuit chip is bonded.

8. The radio frequency identification tag according to claim 1, wherein the integrated circuit comprises at least one selected from a group consisting of a communication circuit, a memory, and a controller circuit configured to record and read data without manufacturing contact.

9. The radio frequency identification tag according to claim 1, wherein the integrated circuit comprises a pair of electrodes configured to provide electrical connections to the antenna, and further comprises a plurality of dummy posts 39a configured to adjust a height of the integrated circuit.

10. The radio frequency identification tag according to claim 1, further comprising:
a pair of through holes formed in the base with one through hole formed at each of the base; and
a thermosetting material filled in a rear surface of the base through each through hole.

11. A method for manufacturing a radio frequency identification tag, the method comprising:
forming an antenna on a base;
forming a plurality of protrusions on a surface of the base opposite to the antenna surface;
forming a through hole on the base;
mounting an integrated circuit chip on the base;
filling a thermosetting material in the surface of the base opposite to the antenna surface through the through hole; and
heating and pressurizing the thermosetting material.

12. The method according to claim 11, further comprising:
reinforcing the integrated circuit using a reinforcing plate,
wherein the reinforcing plate comprises a combination of a glass material and an epoxy material.

13. The method according to claim 11, further comprising:
deforming the base downward using a suction device by suctioning the base through the through hole,
wherein the deformed base is bent away from the surface on which the integrated circuit is bonded.

14. The method according to claim 11, wherein the filling comprises filling the thermosetting material through an opening in the antenna.

15. The method according to claim 14, wherein the filling the thermosetting material through the opening in the antenna forms a bonding layer configured to bond a rear surface of the integrated circuit onto the base.

16. The method according to claim 11, wherein the heating and pressurizing the thermosetting material is performed using a bonding device.

17. The method according to claim 11, further comprising:
disposing an elastomer member and a reinforcing plate on the base.
